(19) United States
(12) Patent Application Publication
(10) Pub. No.: US 2005/0273853 A1
(43) Pub. Date: Dec. 8, 2005

(54) QUARANTINE NETWORKING

(75) Inventors: Yashihiro OBA, Forte Lee, NJ (US); Ashutosh DUTTA, Bridgewater, NJ (US); Subir DAS, Kendall Park, NJ (US)

Correspondence Address: WATCHSTONE P + D, 1300 EYE STREET, NW, 400 EAST TOWER, WASHINGTON, DC, 20005, US

(73) Assignees: TOSHIBA AMERICA RESEARCH, INC., Piscataway, NJ (US); TELCORDIA INC., Piscataway, NJ (US)

(21) Appl. No.: 10/908,199

(22) Filed: May 2, 2005

Related U.S. Application Data
(60) Provisional application No. 60/573,702, filed on May 24, 2004.

(51) Int. Cl. H04L 12/28

(52) U.S. Cl. 726/22

(57) ABSTRACT

In some illustrative embodiments, a novel system and method is provided that includes a quarantining architecture for quarantining of clients, including: a) an unauthenticated network; b) a quarantine network; and c) a safe network.

### CROSS-REFERENCE TO RELATED APPLICATIONS

The present application claims priority to U.S. Provisional Patent Application Ser. No. 60/573,702 filed on May 24, 2004 entitled Quarantine Networking, the entire disclosure of which, including Appendices, is incorporated herein by reference.

### FIELD OF THE INVENTION

The present application relates to quarantine networking and, in some preferred embodiments, to systems and methods employed in performing authentication and quarantining of devices, such as, e.g., mobile devices during movement or switching between networks.

### GENERAL BACKGROUND DISCUSSIONS

Networks and Internet Protocol

There are many types of computer networks, with the Internet having the most notoriety. The Internet is a worldwide network of computer networks. Today, the Internet is a public and self-sustaining network that is available to many millions of users. The Internet uses a set of communication protocols called TCP/IP (i.e., Transmission Control Protocol/Internet Protocol) to connect hosts. The Internet has a communications infrastructure known as the Internet backbone. Access to the Internet backbone is largely controlled by Internet Service Providers (ISPs) that resell access to corporations and individuals.

With respect to IP (Internet Protocol), this is a protocol by which data can be sent from one device (e.g., a phone, a PDA [Personal Digital Assistant], a computer, etc.) to another device on a network. There are a variety of versions of IP today, including, e.g., IPv4, IPv6, etc. Each host device on the network has at least one IP address that is its own unique identifier.

IP is a connectionless protocol. The connection between end points during a communication is not continuous. When a user sends or receives data or messages, the data or messages are divided into components known as packets. Every packet is treated as an independent unit of data.

In order to standardize the transmission between points over the Internet or the like networks, an OSI (Open Systems Interconnection) model was established. The OSI model separates the communications processes between two points in a network into seven stacked layers, with each layer adding its own set of functions. Each device handles a message so that there is a downward flow through each layer at a sending end point and an upward flow through the layers at a receiving end point. The programming and/or hardware that provides the seven layers of function is typically a combination of device operating systems, application software, TCP/IP and/or other transport and network protocols, and other software and hardware.

Typically, the top four layers are used when a message passes from or to a user and the bottom three layers are used when a message passes through a device (e.g., an IP host device). An IP host is any device on the network that is capable of transmitting and receiving IP packets, such as a server, a router or a workstation. Messages destined for some other host are not passed up to the upper layers but are forwarded to the other host. In the OSI and other similar models, IP is in Layer-3, the network layer. The layers of the OSI model are listed below.

Layer-7 (i.e., the application layer) is a layer at which, e.g., communication partners are identified, quality of service is identified, user authentication and privacy are considered, constraints on data syntax are identified, etc.

Layer-6 (i.e., the presentation layer) is a layer that, e.g., converts incoming and outgoing data from one presentation format to another, etc.

Layer-5 (i.e., the session layer) is a layer that, e.g., sets up, coordinates, and terminates conversations, exchanges and dialogs between the applications, etc.

Layer-4 (i.e., the transport layer) is a layer that, e.g., manages end-to-end control and error-checking, etc.

Layer-3 (i.e., the network layer) is a layer that, e.g., handles routing and forwarding, etc.

Layer-2 (i.e., the data-link layer) is a layer that, e.g., provides synchronization for the physical level, does bit-stuffing and furnishes transmission protocol knowledge and management, etc. The Institute of Electrical and Electronics Engineers (IEEE) sub-divides the data-link layer into two further sub-layers, the MAC (Media Access Control) layer that controls the data transfer to and from the physical layer and the LLC (Logical Link Control) layer that interfaces with the network layer and interprets commands and performs error recovery.

Layer-1 (i.e., the physical layer) is a layer that, e.g., conveys the bit stream through the network at the physical level. The IEEE sub-divides the physical layer into the PLCP (Physical Layer Convergence Procedure) sub-layer and the PMD (Physical Medium Dependent) sub-layer.

In this document, layers higher than layer-2 (such as, e.g., layers including the network layer or layer-3 in the OSI model and the like) are referred to as the higher-layers.

Wireless Networks:

Wireless networks can incorporate a variety of types of mobile devices, such as, e.g., cellular and wireless telephones, PCs (personal computers), laptop computers, wearable computers, cordless phones, pagers, headsets, printers, PDAs, etc. For example, mobile devices may include digital systems to secure fast wireless transmissions of voice and/or data. Typical mobile devices include some or all of the following components: a transceiver (i.e., a transmitter and a receiver, including, e.g., a single chip transceiver with an integrated transmitter, receiver and, if desired, other functions); an antenna; a processor; one or more audio transducers (for example, a speaker or a microphone as in devices for audio communications); electromagnetic data storage (such as, e.g., ROM, RAM, digital data storage, etc., such as in devices where data processing is provided); memory; flash memory; a full chip set or integrated circuit; interfaces (such as, e.g., USB, CODEC, UART, PCM, etc.); and/or the like.

Wireless LANs (WLANs) in which a mobile user can connect to a local area network (LAN) through a wireless connection may be employed for wireless communications. Wireless communications can include, e.g., communications that propagate via electromagnetic waves, such as light, infrared, radio, microwave. There are a variety of WLAN standards that currently exist, such as, e.g., Bluetooth, IEEE 802.11, and HomeRF.

By way of example, Bluetooth products may be used to provide links between mobile computers, mobile phones, portable handheld devices, personal digital assistants (PDAs), and other mobile devices and connectivity to the Internet. Bluetooth is a computing and telecommunications industry specification that details how mobile devices can easily interconnect with each other and with non-mobile devices using a short-range wireless connection. Bluetooth creates a digital wireless protocol to address end-user problems arising from the proliferation of various mobile devices that need to keep data synchronized and consistent from one device to another, thereby allowing equipment from different vendors to work seamlessly together. Bluetooth devices may be named according to a common naming concept. For example, a Bluetooth device may possess a Bluetooth Device Name (BDN) or a name associated with a unique Bluetooth Device Address (BDA). Bluetooth devices may also participate in an Internet Protocol (IP) network. If a Bluetooth device functions on an IP network, it may be provided with an IP address and an IP (network) name. Thus, a Bluetooth Device configured to participate on an IP network may contain, e.g., a BDN, a BDA, an IP address and an IP name. The term “IP name” refers to a name corresponding to an IP address of an interface.

An IEEE standard, IEEE 802.11, specifies technologies for wireless LANs and devices. Using 802.11, wireless networking may be accomplished with each single base station supporting several devices. In some examples, devices may come pre-equipped with wireless hardware or a user may install a separate piece of hardware, such as a card, that may include an antenna. By way of example, devices used in 802.11 typically include three notable elements, whether or not the device is an access point (AP), a mobile station (STA), a bridge, a PCMCIA card or another device: a radio transceiver; an antenna; and a MAC (Media Access Control) layer that controls packet flow between points in a network.

In addition, Multiple Interface Devices (MIDs) may be utilized in some wireless networks. MIDs may contain two independent network interfaces, such as a Bluetooth interface and an 802.11 interface, thus allowing the MID to participate on two separate networks as well as to interface with Bluetooth devices. The MID may have an IP address and a common IP (network) name associated with the IP address.

Wireless network devices may include, but are not limited to Bluetooth devices, Multiple Interface Devices (MIDs), 802.11x devices (IEEE 802.11 devices including, e.g., 802.11a, 802.11b and 802.11g devices), HomeRF (Home Radio Frequency) devices, Wi-Fi (Wireless Fidelity) devices, GPRS (General Packet Radio Service) devices, 3G cellular devices, 2.5G cellular devices, GSM (Global System for Mobile Communications) devices, EDGE (Enhanced Data for GSM Evolution) devices, TDMA type (Time Division Multiple Access) devices, or CDMA type (Code Division Multiple Access) devices, including CDMA2000. Each network device may contain addresses of varying types including but not limited to an IP address, a Bluetooth Device Address, a Bluetooth Common Name, a Bluetooth IP address, a Bluetooth IP Common Name, an 802.11 IP Address, an 802.11 IP common Name, or an IEEE MAC address.

Wireless networks can also involve methods and protocols found in, e.g., Mobile IP (Internet Protocol) systems, in PCS systems, and in other mobile network systems. With respect to Mobile IP, this involves a standard communications protocol created by the Internet Engineering Task Force (IETF). With Mobile IP, mobile device users can move across networks while maintaining their IP Address assigned once. See Request for Comments (RFC) 3344. NB: RFCs are formal documents of the Internet Engineering Task Force (IETF). Mobile IP enhances Internet Protocol (IP) and adds means to forward Internet traffic to mobile devices when connecting outside their home network. Mobile IP assigns each mobile node a home address on its home network and a care-of-address (CoA) that identifies the current location of the device within a network and its subnets. When a device is moved to a different network, it receives a new care-of address. A mobility agent on the home network can associate each home address with its care-of address. The mobile node can send the home agent a binding update each time it changes its care-of address using, e.g., Mobile IP.

In basic IP routing (i.e. outside mobile IP), routing mechanisms rely on the assumptions that each network node always has a constant attachment point to, e.g., the Internet and that each node's IP address identifies the network link it is attached to. In this document, the terminology “node” includes a connection point, which can include, e.g., a redistribution point or an end point for data transmissions, and which can recognize, process and/or forward communications to other nodes. For example, Internet routers can look at, e.g., an IP address prefix or the like identifying a device's network. Then, at a network level, routers can look at, e.g., a set of bits identifying a particular subnet. Then, at a subnet level, routers can look at, e.g., a set of bits identifying a particular device. With typical mobile IP communications, if a user disconnects a mobile device from, e.g., the Internet and tries to reconnect it at a new subnet, then the device has to be reconfigured with a new IP address, a proper netmask and a default router. Otherwise, routing protocols would not be able to deliver the packets properly.

Handoffs and Changing Network Attachment Points:

A handoff is an act in which a mobile station changes its network attachment point from one point to another, where network attachment points can include, e.g., base stations and IP (Internet Protocol) routers. When a handoff occurs with a change in attaching, for example, base stations and IP routers, it typically includes a layer-2 handoff and a layer-3 handoff, respectively. The layer-2 handoff and the layer-3 handoff may occur at about the same time. During any handoff, the system needs to re-establish states maintained between the mobile station and the new network attachment point. These states related to handoff are also referred to as handoff contexts or simply as “contexts.”

There are two types of contexts, transferable contexts and non-transferable contexts. The transferable contexts are transferable between the old and new attachment points while the non-transferable contexts need to be established either from scratch or by using transferable contexts. Illustrative transferable contexts can include, e.g., authentication contexts that are used, e.g., for re-authenticating the mobile and QoS (Quality of Service) contexts that are used, e.g., for allocating network resources sufficiently to provide a particular grade of service for the mobile. A dynamically assigned IP address of the mobile is an illustrative non-transferable context. Layer-2 and layer-3 cipher keys, such as TKIP (Temporal Key Integrity Protocol) and CCMP (Counter mode with CBC-MAC Protocol) cipher keys in 802.11i (see, e.g., Reference #11 incorporated herein below) and IPsec AH (Authentication Header) and ESP (Encapsulation Security Payload) cipher keys (see, e.g., References #15, #16 and #17 incorporated herein below) that are used for protecting data packets transmitted between the mobile station and an access point (AP) or router, are other illustrative non-transferable contexts, since those keys are associated with a particular pair of MAC (Media Access Control) or IP addresses of the two entities and need to be re-established based on negotiations between them.

For reference, as discussed above, 802.11 is a family of specifications for wireless local area networks (WLANs) developed by a working group of the Institute of Electrical and Electronics Engineers (IEEE), which includes, e.g., specifications in the families 802.11, 802.11a, 802.11b, and 802.11g which use ethernet protocol and CSMA/CA (carrier sense multiple access with collision avoidance) for path sharing. See, e.g., Reference #13 incorporated herein below. In addition, 802.11i is a developing IEEE standard for security in WLANs. In addition, IPsec (Internet Protocol Security) is a framework for a set of protocols for security at the network or packet processing layer of network communication. In addition, a MAC address involves, e.g., a device's unique hardware address and can be used by the media access control sub-layer of the data-link layer, while an IP address involves, e.g., a number that identifies each sender or receiver of information that is sent in packets across, e.g., the Internet (such as, e.g., a 32 bit number in the most widely installed level of the Internet Protocol [IP], a 128 bit number in IPv6, a Classless Inter-Domain Routing (CIDR) network address and/or the like).

The preferred embodiments provide substantial improvements over and/or advances beyond existing systems and methods, including, e.g., systems and methods described in the following references, the entire disclosures of which references are each incorporated herein by reference:
Reference #1: B. Aboba, “IEEE 802.1X Pre-Authentication”, IEEE 802.11-02/389r1, June 2002.
Reference #2: B. Aboba and D. Simon, “PPP EAP TLS Authentication Protocol”, RFC 271 6, October 1999.
Reference #3: L. Blunk, J. Vollbrecht, B. Aboba, J. Carlson and H. Levkowetz, “Extensible Authentication Protocol (EAP), Internet-Draft, Work in progress (to obsolete RFC 2284), May 2003 (see, also, e.g., November, 2003 document).
Reference #4: R. Droms and W. Arbaugh, “Authentication for DHCP Messages”, RFC 3118, June 2001.
Reference #5: R. Droms, “Dynamic Host Configuration Protocol,” RFC 2131, March 1997.
Reference #6: P. Funk, S. Blake-Wilson, “EAP Tunneled TLS Authentication Protocol (EAP-TTLS)”, Internet-Draft, Work in progress, November 2002 (see also, e.g., August, 2003 document).
Reference #7: D. Forsberg, Y. Ohba, B. Patil, H. Tschofenig and A. Yegin, “Protocol for Carrying Authentication for Network Access (PANA)”, Internet-Draft, Work in progress, March 2003 (see also, e.g., October, 2003 document).
Reference #8: R. Glenn and S. Kent, “The Null Encryption Algorithm and Its Use With IPsec,” RFC 2410, November 1998.
Reference #9: D. Harkins and D. Carrel, “The Internet Key Exchange (IKE)”, RFC 2409, November 1998.
Reference #10: IEEE Standard for Local and Metropolitan Area Networks, “Port-Based Network Access Control”, IEEE Std 802.1X-2001.
Reference #11: IEEE Standard for Local and Metropolitan Area Networks, “Wireless Medium Access Control (MAC) and physical layer (PHY) specifications: Medium Access Control (MAC) Security Enhancements,” IEEE Std 802.11i/D4.0, May 2003 (see also, e.g., IEEE Std 802.11i/D7.0, October 2003 document).
Reference #12: IEEE Standard for Local and Metropolitan Area Networks, “Draft Recommended Practice for Multi-Vendor Access Point Interoperability via an Inter-Access Point Protocol Across Distribution Systems Supporting IEEE 802.11 Operation,” IEEE P802.11F/D5, January 2003.
Reference #13: IEEE Standard for Local and Metropolitan Area Networks, “Wireless LAN Medium Access Control (MAC) and Physical Layer (PHY) Specifications,” ANSI/IEEE Std 802.11, 1999 Edition, 1999.
Reference #14: J. Loughney, M. Nakhjiri, C. Perkins and R. Koodli, “Context Transfer Protocol,” Internet-Draft, Work in progress, June 2003 (see also, e.g., October, 2003 document).
Reference #15: C. Kaufman, “Internet Key Exchange (IKEv2) Protocol”, Internet-Draft, Work in progress, April 2003 (see also, e.g., Oct. 9, 2003 and January, 2004 documents).
Reference #16: S. Kent and R. Atkinson, “IP Authentication Header,” RFC 2402, November 1998.
Reference #17: S. Kent and R. Atkinson, “IP Encapsulating Security Payload (ESP),” RFC 2406, November 1998.
Reference #18: T. Kivinen, “DHCP over IKE”, Internet-Draft, Work in progress, April 2003.
Reference #20: M. Liebsch, A. Singh, H. Chaskar and D. Funato, “Candidate Access Router Discovery”, Internet-Draft, work in Progress, March 2003 (see also, e.g., September, 2003 and November, 2003 documents).
Reference #21: A. Palekar, D. Simon, G. Zorn and S. Josefsson, “Protected EAP Protocol (PEAP)”, Internet-Draft, Work in Progress, March 2003 (see also “Protected EAP Protocol (PEAP) Version 2,” October, 2003).
Reference #22: B. Patel, B. Aboba, S. Kelly and V. Gupta, “Dynamic Host Configuration Protocol (DHCPv4) Configuration of IPsec Tunnel Mode”, RFC 3456, January 2003.
Reference #23: J. Puthenkulam, V. Lortz, A. Palekar and D. Simon, “The Compound Authentication Binding Problem”, Internet-Draft, Work in Progress, March 2003 (see also, e.g., October, 2003 document).
Reference #24: R. Seifert, “The Switch Book—The Complete Guide to LAN Switching Technology”, Wiley Computer Publishing, ISBN 0-471-34586-5.
Reference #25: Y. Sheffer, H. Krawczyk and B. Aboba, “PIC, A Pre-IKE Credential Provisioning Protocol”, Internet-Draft, Work in progress, October 2002.
Reference #26: H. Tschofenig, A. Yegin and D. Forsburg, “Bootstrapping RFC3118 Delayed Authentication using PANA”, Internet-Draft, June 2003 (see also, e.g., October, 2003 document).
Reference #27: M. Kulkarni, A Patel and K. Leung, “Mobile IPv4 Dynamic Home Agent Assignment”, IETF Internet-Draft, Jan. 8, 2004.
   Background to Quarantine Networking:

Typically, network sites are secured by the use of firewalls, which help protect against outside attacks on a network. This so-called “border/pelimeter defense model” has substantial limitations and other methods have been considered to improve security. See, e.g., draft-kondo-quarantine-overview-00.txt incorporated herein by reference below. One of the most significant problems with the border defense model involves mobile node control. A mobile node, such as, e.g., a note PC or any other mobile node can readily move outside of the “border” in this border defense model and can readily connect to other devices, such as, e.g., LANs, dial up connections and/or the like. These mobile nodes may be uncontrolled when they are outside of the network. Then, upon return to the network, they can bring commensurate problems. Moreover, wireless LANs and the like can further cause security risks since the use of wireless signals (e.g., radio waves) can increase risk that others may gain access to the system. In this context, some models have been considered (e.g., quarantine networks) to improve upon such background security methods. Some existing quarantine and the like models and/or products are described below for reference.

Model 1: Draft-Kondo-Quarantine-Overview-00.txt:

A first model is described in draft-kondo-quarantine-overview-00.txt, which is incorporated herein by reference in its entirety and attached to the above-said provisional application 60/573,702 at Appendix A.

This model was written by WIDE Secure6 WG in Japan. It describes a generic quarantine model. With reference to FIG. 1, the model works essentially as follows:

1. The client (CL) connects to the switch (SW). Before inspection is completed successfully, the CL's traffic is forced to go through the quarantine path.

2. The quarantine authentication server (QAS) requests inspection to the CL and receives profile information from the CL. During this process, the prevention information server (PIS) is contacted from the QAS to check the profile information against prevention information.

3. Based on the inspection result, the QAS requests admission action to the network admission controller (NAC). The NAC updates the router (RT) to connect the CL via a secure path. Here, the IP address may also be updated.

With respect to this first model, the relationship with network access authentication is not clearly set forth.

Model 2: CISCO NAC (Network Admission Control):

A second model is that of CISCO NAC. This model appears to involve a planned quarantine networking product from CISCO, working with anti-virus vendors such as Network Associates, Symantec and Trend Micro.

In this model, inspection information is apparently carried in EAP (Extensible Authentication Protocol):

1. The model apparently uses IEEE 802.1X when EAP is carried at IEEE 802 MAC layer or uses UDP to carry EAP to remote gateways. It is not clear whether the model uses PANA (Protocol for carrying Authentication for Network Access) or a custom (i.e., their own) protocol to carry EAP over UDP.

2. In the latter case, an IPsec VPN is apparently allowed to be established only for inspected users.

This model supports both LAN and remote access clients. However, client software is required in this model.

Model 3: Quarantine System Based On Authenticated VLAN:

This model appears to involve a product planned for release in about the 3rd quarter of 2004. See, e.g., the news document found at the following URL htt://itpro.nikkeibp.co.jp/free/SI/NEWS/20040205/139376/ which document is incorporated herein by reference in its entirety and attached to the above-said provisional application 60/573,702 at Appendix B. This product will apparently have a substantial price of greater than or equal to $50,000.

In this model, the following steps appear to be involved:

1. A client is connected to an unauthenticated VLAN (Virtual LAN) and obtains a temporary IP address;

2. Inspection is performed in the unauthenticated VLAN;

3. After the inspection, the client is connected to an authenticated VLAN and renews the IP address.

This model apparently does not support remote access clients. In addition, in this model, client software is required. In this model, it is unclear what kind of network access authentication may possibly be employed.

Model 4: Zone Lab (Integrity):

This model is described in the document at the following URL http://download.zonelabs.com/bin/media/pdf/IntegrityClientless_prodsheet.pdf, which document is attached to the above-said provisional application 60/573,702 at Appendix C, and the entire disclosure of which is incorporated herein by reference.

Among other things, this model apparently does not support LAN clients (i.e., it is for remote access clients only). In this model, no client software is needed (i.e., it is agent-less).

Model 5: Still Secure (Safe Access):

This model is described in the document at the following URL http://www.stillsecure.com/products/sa, which document is attached to the above-said provisional application 60/573,702 at Appendix D, and the entire disclosure of which is incorporated herein by reference.

In this Safe Access model, apparently administrators create “access” policies that: (1) define which applications and services are permitted; and (2) specify the actions to be taken when devices do not comply. Apparently, Safe Access automatically applies access policies to devices as they log onto the network.

Based on test results, devices are either permitted or denied network access or quarantined to a specific part of the network, thus enforcing the organizational security standards. Safe Access tracks all testing and connection activity and produces a range of reports for auditors, managers, and IT staff.

Apparently, this model provides support for both LAN and remote access clients. In addition, with this model, no client software is needed (i.e., it is agent-less).

Overview of the Above-Described Existing Models:

The following Chart I provides a summary overview of some of the features found in the above-described existing models.

FEATURE SETS

| | | Integration | LAN | Remote |
|---|---|---|---|---|
| | Agent- | with client | access | access |
| | based | authentication | support | support |
| Cisco | Yes | Yes | Yes | Yes |
| NEC | Yes | ? | Yes | No |
| Zone Lab | No | No | No | Yes |
| StillSecure | No | No | Yes | Yes |

### CHART I

While a variety of quarantining systems and methods are known, there remains a need for improved systems and methods.

### SUMMARY OF THE PREFERRED EMBODIMENTS

The preferred embodiments of the present invention can significantly improve upon existing methods and/or apparatuses.

According to some embodiments, a quarantining architecture for quarantining clients, comprises:

a) an unauthenticated network;

b) a quarantine network; and

c) a safe network.

In some embodiments, the architecture further includes an authentication agent in the unauthenticated network that controls a switching point and a quarantining agent in the quarantine network that controls the switching point. In some embodiments, the authentication agent connects to the unauthenticated network for initial authentication. In some embodiments, the authentication agent connects to the quarantine network and/or the safe network for re-authentication. In some embodiments, the quarantine agent inspects the client and when this inspection fails, the quarantine agent effects or enforces the client to upgrade the client software. In some embodiments, if the upgrade fails or is unsuccessful, the client is either a) disconnected from the network or b) connected back to the unauthenticated network.

In some embodiments, the architecture further includes means for switching clients in the safe network to the quarantine network or to the unauthenticated network based on certain circumstances or policy. In some embodiments, the means includes means for switching based on one or more of the following: 1) by checking and switching clients based upon circumstances or policy periodically; 2) by checking and switching clients based upon circumstances or policy at the time when new data and/or information is received or arrives; and/or 3) by checking and switching clients based upon circumstances or policy or when they are found to be unfortunately infected in the secure network.

In some embodiments, the networks are logically separated, and per-packet encryption, integrity protection and/or replay protection is used for traffic separation among the networks and/or among clients.

In some embodiments, the architecture includes means for skipping quarantining if a client is successfully authenticated and a valid inspection record already exists for the client.

In some embodiments, inspection information is exchanged between a client and a quarantine agent, which is carried in application-layer protocol messages.

In some embodiments, a switching point is co-located with an IPsec gateway, and a switching and IP address change is based on creating or modifying an IPsec SA.

In some embodiments, a switching and IP address change is triggered by a network side.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by a way of example, and not limitation, in the accompanying figures, in which:

FIG. 1 shows an illustrative background quarantine model; and

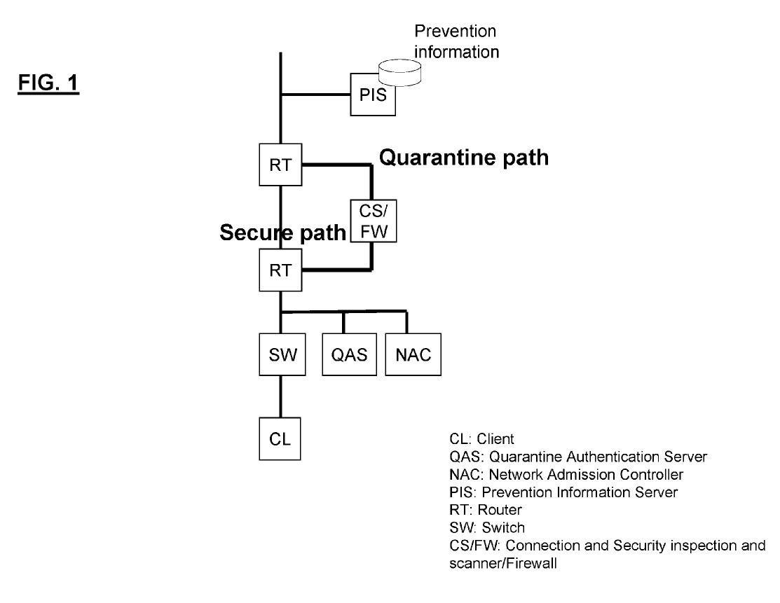

FIG. 2 shows illustrative architecture that may be employed in some preferred embodiments of the invention.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and that such examples are not intended to limit the invention to preferred embodiments described herein and/or illustrated herein.

Introduction to the Preferred Embodiments:

The preferred embodiments of the present invention have been developed taking into account some notable deficiencies and limitations noted in existing systems and methods. Among other things, the present inventor(s) have discovered that:

1. A solution that supports both LAN access and remote access is more desirable.

2. With respect to whether or not an agent-less versus an agent-based system is employed:

An agent-based model can provide more features such as, e.g., client isolation as well as independency from anti-virus software and/or operating system (OS);

An agent-less model may not provide a good isolation of clients (e.g., filtering of only suspicious packets may be possible while filtering of other packets from the same clients may not be possible).

3. The above-noted CISCO model, by way of example, has some deficiencies because quarantining is too tightly coupled with authentication. In that regard, the present inventor(s) have determined that carrying inspection information in, e.g., IEEE 802.1X or EAP over UDP is less flexible and that a more flexible model is needed.

The present inventor(s) have found that there is a problem in that, among other things, no general solution is available and that, in particular, the relationship between network access and authentication is not clear in existing systems.

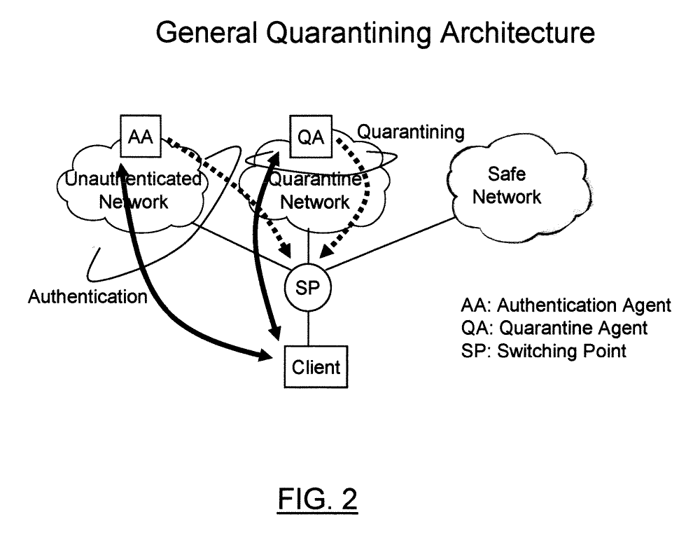

In this context, the present inventors developed, among other things, the preferred architecture shown in FIG. 2 which can be employed in some preferred embodiments of the invention. In this regard, FIG. 2 illustrates the use of an unauthenticated network having an authentication agent (AA) that is capable of controlling the switching point (SP), a quarantine network having a quarantine agent (QA) that is also capable of controlling the switching point (SP), and a safe network for quarantining in relation to clients, such as, e.g., any appropriate clients (such as, by way of example, mobile node personal computers (PCs), desk top PCs and/or any other type of devices).

In the preferred embodiments, a minimum relationship is established between network access authentication and quarantining and, most preferably, network access authentication and quarantining are essentially not tied together and separated.

The Three Types of Networks in the Preferred Embodiments:

The three types of networks shown in FIG. 2 are described in further detail below according to the preferred embodiments.

1. UNAUTHENTICATED NETWORK: With respect to the unauthenticated network, this preferably involves:
a network where unauthenticated clients are connected; and
a network where initial authentication happens.

In operation, processes at the unauthenticated network are carried out. Then, if successful, processes at the quarantine network are carried out.

2. QUARANTINE NETWORK: With respect to the quarantine network, this network preferably involves:
a network where authenticated but un-inspected clients are connected;
a network where inspection and upgrades (such as, e.g., software upgrades like OS, application, etc.) happen;

With respect to inspection, this can include, e.g., inspection of software, firmware and/or hardware. Software inspection can include, e.g., OS type inspection, antivirus checks, software version checks, software patch or module checks, etc. With respect to upgrades, software upgrades can involve, e.g., the pushing of software, the downloading of software and/or the like to a client upon, e.g., an inspection determination.

In some embodiments, the unauthenticated network and the quarantine network may be the same network. In some embodiments, the unauthenticated network and the quarantine network can be physically and/or logically separated.

As indicated above, in operation, processes at the unauthenticated network are carried out, then if successful, processes at the quarantine network are carried out. Thereafter, if these are both successfully passed through, processes at the safe network are carried out.

In general, separation of inspection at the quarantine network can be desirable because, among other things, it may help to save resources. For example, the quarantine network can avoid inspection of unathenticated clients which may otherwise take resources to inspect.

3. SAFE NETWORK: With respect to the safe network, this network preferably involves:
a network where authenticated and inspected clients are connected (i.e., after successfully passing through these two other networks);
a network where application traffic goes through (this may include, e.g., normal operation, such as, e.g., normal data application traffic, such as, e.g., e-mail, Web traffic, etc.);
a network that is preferably physically and/or logically separated from both the unauthenticated network and the quarantine network.

In the preferred embodiments, clients in the safe network may be switched to the quarantine network or to the unauthenticated network based on certain circumstances or policy. In some embodiments, such a switch may occur based on one or more of the following: 1) by checking and switching clients based upon circumstances or policy periodically (such as, e.g., on periodic time periods, like daily, weekly, bi-weekly, monthly and/or the like); 2) by checking and switching clients based upon circumstances or policy at the time when new data and/or information is received, arrives or the like, such as, e.g., upon the arrival of a new prevention database, new prevention software and/or the like (by way of example, new software to upgrade clients may arrive and/or a new prevention inspection database may arrive to compare clients with and/or the like); and/or 3) by checking and switching clients based upon circumstances or policy or when they are found to be unfortunately infected (such as, e.g., containing a software virus and/or the like) in the secure network.

Note 1: In some embodiments, each of these three networks may be, e.g., on the same IP link as the client or may be multiple IP hops away from the client. Thus, they may involve LAN access clients and/or remote access clients.

Note 2: In some embodiments, when the networks are logically separated, per-packet encryption, integrity protection and/or replay protection may be used for traffic separation among networks and/or among clients. With respect to client separation, this may be helpful for, among other things, providing better isolation. For example, there may be multiple clients at a quarantine network at the same time, so this may give a lower likelihood that they may affect each other.

The Functional Entities in the Preferred Embodiments:

As shown in FIG. 2, in the preferred embodiments, the following three functional entities are preferably employed: an authentication agent (AA); a quarantine agent (QA); and a switching point (SP).

With respect to the authentication agent, this agent preferably authenticates the client. In the preferred embodiments, the authentication agent connects to the unauthenticated network for initial authentication. In addition, in some embodiments, the authentication agent may also connect to the quarantine network and/or the safe network for re-authentication.

With respect to the quarantine agent (QA), this agent preferably inspects the client. In the preferred embodiments, when this inspection fails, the agent preferably effects or enforces the client to upgrade the client software. In the preferred embodiments, if this upgrading fails or is unsuccessful (such as, e.g., not succeeding within a certain amount of time or not succeeding based on other conditions), the client is either a) disconnected from the network or b) connected back to the unauthenticated network.

With respect to the switching point (SP), this is the entity that switches traffic. In the preferred embodiments, the SP operates to switch traffic based on authorization (e.g., control) given independently by both the authentication agent (AA) and the quarantine agent (QA). In some embodiments, the SP may be co-located on a wireless LAN access point, an Ethernet switch or an IPsec gateway. With respect to functionality of an IPsec gateway, see, e.g., applicant's co-pending application Ser. No. ______, filed on ______, entitled ______, the entire disclosure of which is incorporated herein by reference.

In some embodiments, some or all of the authentication agent, the quarantine agent and the switching point can be co-located together. In some embodiments, the authentication agent and the quarantine agent may have another connection to the safe network—such as, e.g., so that re-authorization can occur in the safe network, for inspection, upgrading and/or the like.

The Inspection Record:

In the preferred embodiments, the quarantine agent (QA) generates an inspection record. Preferably, the QA generates the inspection record when a client has been inspected successfully or unsuccessfully. In this manner, an inspection history can be created that indicates if a given client has been inspected successfully or unsuccessfully.

In the preferred embodiments, the inspection record includes at least some, preferably all, of the following:
identification information (such as, e.g., a device identifier and a client identification)(note: may need device identifiers because, e.g., a client may have multiple devices);
inspection time (such as, e.g., when the inspection is done); and/or
a list of inspection items (such as, e.g., attribute names and/or the like).

In the preferred embodiments, an inspection item includes at least some, preferably all, of the following:
inspection data name (such as, e.g., an “OS name” or the like);
inspection data version (such as, e.g., “Windows XP” or the like); and/or
inspection results (such as, e.g., “pass” or “fail” or the like)(in some embodiments, the inspection result will be a binary value [such as, yes or no, 1 or 0 and/or the like], but in some instances, it may include non-binary values, such as, e.g., categorization, or it may include a scheme of X out of Y items required to pass and/or the like).

In some of the preferred embodiments, an inspection record is said to be valid if:
all results for the required inspection items indicate “pass”, and
the inspection time is valid.

In some preferred embodiments, an inspection time is considered to be valid if it is newer than the last time when a prevention database and/or the like (e.g., which is used for inspection) was updated.

In some embodiments, there may also or alternatively be optional inspection items.

In some embodiments, the inspection records may be stored somewhere in the safe network (such as, e.g., upon an AAA server) and/or in the quarantine network.

Optimization:

In some embodiments, quarantining by the QA may be skipped under certain conditions. For example, quarantining may be skipped in some embodiments if the client is successfully authenticated and a valid inspection record already exists for the client. In order to do this, the AA may, e.g., directly or indirectly contact the entity that stores the inspection record. In some embodiments, an AAA protocol (such as, e.g., Diameter) may be used for these purposes (e.g., for such contact).

In this regard, once a client is authenticated and the inspection record is available for the authorized client, it may be possible to skip quarantining under certain pre-established conditions or circumstances. For example, it may be possible to skip quarantining if the inspection record indicates that the client was already successfully inspected within a certain date or time period and/or if the inspection record is determined to indicate some other appropriate information.

Per-Packet Protection:

In the preferred embodiments, the traffic among the three networks is logically separated with using per-packet protection (e.g., per-packet encryption, integrity protection and/or replay protection) and, in such cases, the following can be employed:
Layer 2 protection: the layer 2 protection can include, e.g., IEEE 802.11i;
Layer 3 protection: the layer 3 protection can include, e.g., IPsec.

In some embodiments, the per-packet protection is performed between the client and switching point (SP).

In some embodiments, the protection keys are bootstrapped from the initial authentication. And, in some embodiments, the initial authentication may be based on EAP (Extensible Authentication Protocol). And further, in some embodiments, the protocols used for carrying EAP between the client and AA may include: IEEE 802.1X; PANA; IKEv2; and/or the like. That is, when the AA authenticates a client, these latter protocols can be used for carrying authentication information between the authentication agent and the client.

Carrying Inspection Information Between the Client and the QA:

In this regard, in the preferred embodiments, inspection information is exchanged between client and QA. This inspection information can be carried in a number of ways. In some preferred embodiments, the inspection information may be carried in application-layer protocol messages. In some examples, a new application protocol to carry inspection information may be defined. In other examples, the application-layer protocol messages may be protected by the application itself, and the protection keys may be bootstrapped from the initial authentication. This could include dynamic creation from the initial authentication. This could also include a per packet protection provided at the lower layer and a LAN application protocol on top of the protected lower layer.

In the preferred embodiments, this carrying of inspection information between the client and the QA involves an application layer protocol, rather than carrying with authentication information, in a manner that the system can effectively work with any authentication model.

Switching and IP address Change:

In the preferred embodiments, the switching of the client among the unauthenticated network, the quarantine network and/or the safe network requires an IP address change.

In some instances, when the switching point (SP) is co-located with a wireless LAN access point (AP) or an Ethernet switch, the switching and IP address change can be based on changing VLANs. In this regard, the following may occur:
DHCP assigns different address pools per VLAN;
Switching may be triggered through the application protocol that carries inspection information.

In other instances, when the switching point (SP) is co-located with an IPsec gateway, the switching and IP address change can be based on creating and/or modifying an IPsec security association (SA). In this regard, in the preferred embodiments, there are two potential schemes:
Creating a new IPsec SA that has a context associated with the target network to be switched to; and
Modifying the context of an existing IPsec SA to the one associated with the target network.

In the latter instances, switching may be triggered, e.g., through the application protocol that carries inspection information and/or through IKEv2. In this regard, when IKEv2 is employed, the trigger may be carried in an IKEv2 Notify Payload sent by the switching point (SP).

In the preferred embodiments, the switching and the IP address change should be triggered by the network side. In this regard, the network preferably indicates when to switch and how to switch, with a good separation between network authentication and quarantining.

Broad Scope of the Invention:

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure, the following abbreviated terminology may be employed: “e.g.” which means “for example;” and “NB” which means “note well.”

1. A quarantining architecture for quarantining clients, comprising:
a) an unauthenticated network;
b) a quarantine network; and
c) a safe network.

2. The architecture of claim 1, further including an authentication agent in said unauthenticated network that controls a switching point and a quarantining agent in said quarantine network that controls said switching point.

3. The architecture of claim 1, further including means for switching clients in the safe network to the quarantine network or to the unauthenticated network based on certain circumstances or policy.

4. The architecture of claim 3, wherein said means includes means for switching based on one or more of the following: 1) by checking and switching clients based upon circumstances or policy periodically; 2) by checking and switching clients based upon circumstances or policy at the time when new data and/or information is received or arrives; and/or 3) by checking and switching clients based upon circumstances or policy or when they are found to be infected in the secure network.

5. The architecture of claim 1, wherein said networks are logically separated, and per-packet encryption, integrity protection and/or replay protection is used for traffic separation among the networks and/or among clients.

6. The architecture of claim 2, wherein the authentication agent connects to the unauthenticated network for initial authentication.

7. The architecture of claim 2, wherein the authentication agent connects to the quarantine network and/or the safe network for re-authentication.

8. The architecture of claim 2, wherein the quarantine agent inspects the client and when this inspection fails, the quarantine agent effects or enforces the client to upgrade the client software.

9. The architecture of claim 8, wherein if said upgrade fails or is unsuccessful, the client is either a) disconnected from the network or b) connected back to the unauthenticated network.

10. The architecture of claim 1, further including means for skipping quarantining if a client is successfully authenticated and a valid inspection record already exists for the client.

11. The architecture of claim 1, further including that traffic among at least some of the three networks are logically separated with per-packet protection, and including layer 3 protection with IPsec.

12. The architecture of claim 2, wherein the following protocols are used for carrying EAP between the client and the authentication agent: IEEE 802.1X, PANA, and IKEv2.

13. The architecture of claim 2, wherein inspection information is exchanged between client and the quarantine agent, which is carried in application-layer protocol messages.

14. The architecture of claim 2, wherein a switching point is co-located with an IPsec gateway, and a switching and IP address change is based on creating or modifying an IPsec SA.

15. The architecture of claim 2, wherein a switching and IP address change is triggered by a network side.

16. A method of performing quarantine networking of at least one wireless client device, comprising:
a) performing authentication of at least one wireless client via an authentication agent over an unauthenticated network;
b) upon successful authentication of said at least one wireless client at the unauthenticated network, performing inspection of the at least one wireless client via a quarantine agent over a quarantine network; and
c) upon successful authentication and inspection of said at least one wireless client, performing application processes with the at least one wireless client over a safe network.

17. The method of claim 16, wherein said performing inspection includes inspecting software, firmware or hardware of the at least one wireless client.

18. The method of claim 1 7, wherein said performing inspection includes inspection types from the group consisting of operating system inspection, antivirus inspection, software version inspection, software patch inspection, and module inspection, and further including performing software upgrading of the wireless client over said quarantine network.

19. The method of claim 16, wherein said unauthenticated network and said quarantine network are physically or logically separated networks.

20. The method of claim 16, further including switching at least one wireless client from the safe network to the quarantine network or to the unauthenticated network based on circumstances or policy.
